(19) United States
(12) Patent Application Publication
(10) Pub. No.: US 2003/0059762 A1
(43) Pub. Date: Mar. 27, 2003

(54) Textbook distribution apparatus, textbook distribution system, textbook distributing method, textbook distribution program, recording medium in which the textbook distribution program is recorded, and textbook display system

(76) Inventors: Sayuri Fujiwara, Nara-shi (JP); Yasuhisa Itoh, Tenri-shi (JP)

Correspondence Address: NIXON & VANDERHYE P.C., 8th Floor, 1100 North Glebe Rd., Arlington, VA, 22201-4714, US

(21) Appl. No.: 10/217,483

(22) Filed: Aug. 14, 2002

(30) Foreign Application Priority Data
Sep. 25, 2001 (JP) 2001-292212

(51) Int. Cl. G09B 3/00

(52) U.S. Cl. 434/350; 434/362

(57) ABSTRACT

In the present system, textbook data stored in a server is represented and distributed to a teacher's terminal. Because of this, it is not necessary for a textbook issuer to print a sample textbook. Further, especially in the system, the server creates an original data by a combination of a plurality of textbook data in response to an instruction which is supplied from the teacher's terminal and distributes the original data thus created to the teacher's terminal. For the users of the teacher's terminal, this makes it possible to create and obtain their own (original) textbook data. Therefore, the users of the teacher's terminal can create a suitable textbook depending on use conditions (for example, the number or academic ability of students who the users teach or students' academic abilities).

### FIELD OF THE INVENTION

The present invention relates to a textbook distribution apparatus for distributing a textbook to predetermined places, a textbook distribution system, a textbook distributing method, a textbook distribution program, a recording medium in which the textbook distribution program is recorded, and a textbook display system in educational institutions.

### BACKGROUND OF THE INVENTION

Conventionally, education institutions such as an elementary school and a junior high school use textbooks which have cleared a textbook screening carried out by the Minister of Education, Culture, Sports, Science and Technology, the boards of education, etc.

FIG. 15 is an explanatory view showing a flow of a conventional textbook issurance.

As shown in FIG. 15, textbook publishers (issuers) submit their created (edited) textbooks to the Minister of Education, Culture, Sports, Science and Technology. After the textbooks submitted are assayed by the Minister, the textbooks are sent to the boards of education and disclosed at textbook exhibitions for school principals.

Thereafter, the boards of education and the school principals check the content of each textbook and adopt their desired textbooks to report the Minister the number of textbook required. The Minister informs issuers of required types and amounts of the textbooks that have been adopted. Then, the issuers produce and supply in accordance with the required types and amounts of the textbooks.

However, in the processes shown in FIG. 15, it is necessary for the issuers to produce textbooks prior to the adoption (textbook samples) for the textbook screening and for display at the textbook exhibitions in advance. Consequently, it is necessary to secure a space for keeping the textbooks.

Furthermore, textbooks that have not adopted by the school principals are not used. This means that the issuers produce textbooks which might not be used in the end. This arises a problem of waste of paper materials.

### SUMMARY OF THE INVENTION

The present invention is attained to solve the conventional problem as described above. In addition, the object of the present invention is to provide a textbook distribution apparatus, a textbook distribution system, a textbook distributing method, a textbook distribution program, a recording medium in which the textbook distribution program is recorded, and textbook display system which can prevent the production of textbooks which are not used actually.

To achieve the object, a textbook distribution apparatus (present distribution apparatus) in the present invention for distributing a textbook to a predetermined receiver, includes:

a storage section for storing a plurality of textbook data; and

a control section for distributing the textbook data stored in the storage section to an external receiver's terminal in response to an instruction which is supplied from the external receiver's terminal,

wherein the control section is set so as to create an original textbook data by a combination of the plurality of textbook data in response to an instruction which is supplied from a receiver's terminal and to distribute an original textbook data thus created to the receiver's terminal.

The present distribution apparatus is an apparatus for distributing textbooks to predetermined receivers including educational institutions such as an elementary school, a junior high school, and a private preparatory school, a general household, and a company.

Here, the textbook as described above means a reading book for use in classes of the educational institutions or for the purpose of a self-study. Further, the textbook data means a computerized content of the textbook.

Instead of a general distribution (delivery) of a paper textbook, textbook distribution in the present distribution apparatus is set so that the textbook data are distributed to a terminal installed at a receiver's place (hereinafter referred to “receiver's terminal”). That is, in the present distribution apparatus, the above textbook data are stored in the storage section so as to be distributed in response to a request from the receiver's terminal.

This allows the textbook issuer to distribute textbooks, without printing, binding, and delivering the created textbooks, only by storing the textbook data in the present distribution apparatus.

Therefore, the textbook issuer can show the content of the textbook without printing to users (educationalists, etc.) of the receiver's terminal. For the issuer, this makes it possible to prevent the production of the textbook which might not be used in the end.

Further, especially, the present distribution apparatus is set so that the control section creates an original textbook data by a combination of a plurality of textbook data stored in the storage section in accordance with the instruction which is supplied from the receiver's terminal, and it distributes the created original textbook data to the receiver's terminal.

Here, “a combination of textbook data” means to pick out from each textbook data smaller units (for example, chapter, item, etc.) of data which organize the textbook data and to collect them.

According to the present distribution apparatus, this allows the users of the receiver's terminal to create and obtain their own (original) textbook data, using ready-made textbook data.

Therefore, the users of the receiver's terminal can create a suitable textbook data depending on use conditions (for example, the number or an academic ability of students who the users teach).

For a fuller understanding of the nature and advantages of the invention, reference should be made to the ensuing detailed description taken in conjunction with the accompanying drawings.

### BRIEF DESCRIPTION OF THE DRAWINGS

FIG. 1 is an explanatory view showing an arrangement of a textbook distribution system according to one embodiment of the present invention.

FIG. 2 is an explanatory view showing an arrangement of an issuer's terminal, an assayer's terminal, and a teacher's terminal in the system shown in FIG. 1.

FIG. 3 is an explanatory view specifically showing an arrangement of a server in the system shown in FIG. 1.

FIG. 4 is an explanatory view showing guidelines (guideline number) in the system shown in FIG. 1.

FIG. 5 is an explanatory view showing a screen display of the teacher's terminal in the system shown in FIG. 1 in browsing textbook data.

FIG. 6 is an explanatory view showing an example of original data in progress of creation, which is stored in a client data storage section of the server shown in FIG. 3.

FIG. 7 is a flowchart showing a flow of textbook distribution process by the server shown in FIG. 2.

FIG. 8 is an explanatory view showing a main menu displayed on the teacher's terminal in the textbook distribution process shown in FIG. 7.

FIG. 9 is a flowchart showing a flow of display process of textbook sample fair shown as S5 in FIG. 7.

FIG. 10 is a flowchart showing a flow of display process of chapter data shown as S21 in FIG. 9.

FIG. 11 is a flowchart showing a flow of editing process of original data shown as S7 in FIG. 7.

FIG. 12 is a flowchart showing a flow of advice process shown as S9 in FIG. 7.

FIG. 13 is a flowchart showing a flow of charge display process shown as S11 in FIG. 7.

FIG. 14 is an explanatory view showing an arrangement of the system in which a learner's terminal having a capability similar to that of the teacher's terminal is added in the system shown in FIG. 1.

FIG. 15 is an explanatory view showing a flow of the conventional textbook issurance.

### DESCRIPTION OF THE EMBODIMENTS

The following will describe one embodiment of the present invention.

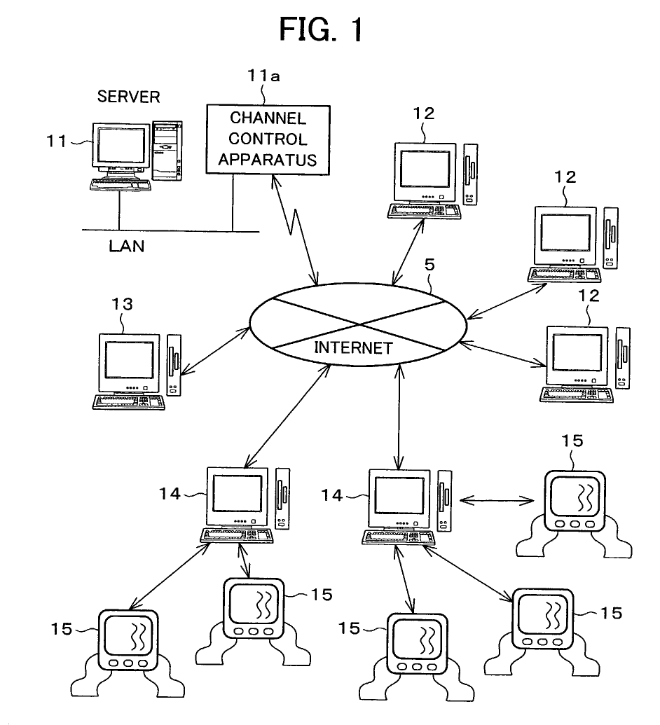

FIG. 1 is an explanatory view showing an arrangement of a textbook distribution system (present system) according to the present embodiment.

The present system is a system for connecting terminals of textbook issuers, an assayer, and teachers as user with each other via a network so that they can electrically (using digital data) transmit and receive with respect to textbooks (distribution of the textbooks for textbook screening and for sale, etc.) among themselves.

Further, the present system allows the teachers to edit the ready-made textbooks by the issuers so as to create their own textbooks (original textbook). In the present system, it is arranged so that the suitability of the thus created original textbooks is determined and the original textbooks are sold to the teachers who are editors of the original textbooks.

As shown in FIG. 1, the present system includes a server 11, issuer's terminals 12, an assayer's terminal 13, and teacher's terminals 14, all of which connected via the Internet 5.

The issuer's terminal 12 is a terminal, installed at a textbook publishing company, which is operated by the textbook issuer (or a textbook editor). The issuer's terminal 12 has capabilities of creating and editing a textbook as well as transferring (transmitting) data of the completed textbook (textbook data) to the server 11 described later.

The assayer's terminal 13 is a terminal, installed at the Ministry of Education, Culture, Sports, Science and Technology, which is operated by the Minister of Education, Culture, Sports, Science and Technology (or an assayer under commission from the Minister of Education, Culture, Sports, Science and Technology). The assayer's terminal 13 has a capability of receiving the textbook data transmitted from the server 11 via the Internet.

Further, the assayer's terminal 13 can also transmit textbook data of the textbook which has cleared the textbook screening.

The teacher's terminal (educationist's terminal, or a receiver's terminal) 14 is a terminal, installed at the educational institutions such as an elementary school and a junior high school, which is operated by teachers who belong to each of the educational institutions. The teacher's terminal 14 has a capability of accessing to (logging in to) the server 11 to browse and download data stored in the server 11.

Further, the teacher's terminal 14 has a dedicated data storage region inside the server 11. The textbook data stored in the server 11 can be copied to the data storage region.

Still further, the teacher's terminal 14 can edit (a limited edition described later) the copied textbook data in response to an instruction supplied from a user (teacher).

Consequently, the users of the teacher's terminal 14 can create their own original textbook data (original data) in the server 11.

Further, each of the teacher's terminals 14 is connected with a plurality of student's terminals 15, which will be described later.

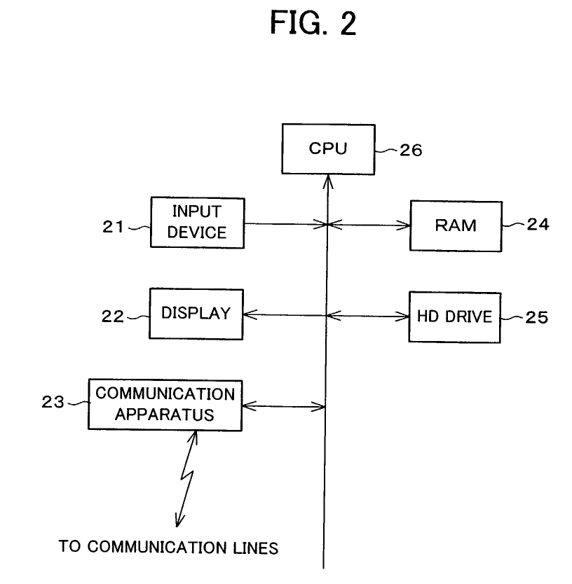

Note that, FIG. 2 is a block diagram showing an arrangement of these terminals 12 through 14. As shown in FIG. 2, each of the terminals 12 through 14 has an input device 21 including a keyboard or a mouse, a display 22 including a CRT or an LCD, a communication apparatus 23 including a modem, a RAM 24 as a storage apparatus, a hard disk drive (HD) 25, a CPU 26 as a control apparatus.

In each of the terminals 12 through 14, the CPU 26 controls the display 22, the communication apparatus 23, the RAM 24, and the HD 25 in response to instructions supplied in the input device 21 by the user (operator) so as to carry out a variety of processes.

Further, the server (textbook distribution apparatus) 11 shown in FIG. 1, a center of the present system, controls all operations of the present system. That is, the server 11 stores the textbook data transmitted from the issuer's terminal 12, and transmits the textbook data to the assayer's terminal 13 in response to a request from the assayer's terminal 13.

Still further, the server 11 also has a capability of storing the textbook data of the textbooks which have cleared the textbook screening, which are transmitted from the issuer's terminal 12, so that the teacher's terminal 14 can browse and download them.

Yet further, the server 11 has a storage region for storing data of the teacher's terminals 14 therein. The server 11 also controls the operation of copying textbook data and the operation of creating the original data, which are carried out by the teacher's terminal 14.

Note that, a channel control apparatus 11a connected via the LAN to the server 11 is a communication apparatus for controlling communication by the server 11.

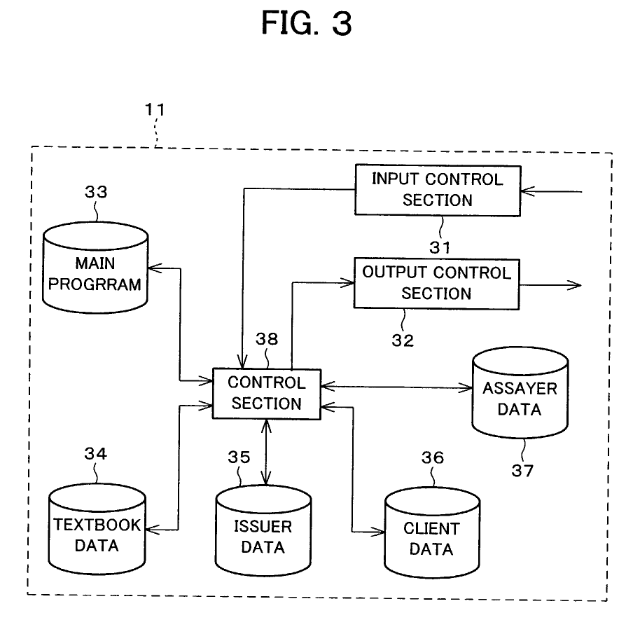

Further, FIG. 3 is an explanatory view specifically showing an arrangement of the server 11. As shown in FIG. 3, the server 11 includes an input control section 31, an output control section 32, a main program storage section 33, a textbook data storage section 34, an issuer data storage section 35, a client data storage section 36, an assayer data storage section 37, and a control section 38.

The input control section 31 functions to receive data transmitted via the channel control apparatus 11a from the terminals 12 through 14. The output control section 32 functions to transmit data to the terminals 12 through 14.

The main program storage section 33 functions to store a program (main program) for realizing the controlling and processing operations which are carried out by the server 11. The textbook data storage section (storage section) 34 stores the ready-made textbook data created by the issuer (the textbooks which have cleared the textbook screening).

The issuer data storage section 35 functions to store data on the textbook issuer (data such as sales records).

The client data storage section 36 functions to store data (belongingness, name, past records of sales, the number of times of downloading textbook data, etc.) on customers (teachers). Also, the client data storage section 36 secures a region for creating original textbook data (original data) for the users (teacher) of the teacher's terminal 14.

The assayer data storage section 37 functions to store data (letters) transmitted and received to and from the Ministry and Minister of Education, Culture, Sports, Science and Technology, etc. which carry out textbook screening.

The control section 38, a hub of the server 11, controls the input control section 31, the output control section 32, the storage sections 33 to 37 to execute all processes of the server 11.

Next, the following will describe the flow of the operations in the present system.

First, described are processes until the textbook data is stored in the textbook data storage section 34.

The issuer computerizes (digitalizes) the content of the textbook to create the textbook data (electronic textbook) equivalent to one copy of textbook. Then, the issuer transmits the textbook data via the Internet 5 to the server 11, using the issuer's terminal 12. Thereafter the server 11 transmits unassayed textbook data, which have been transmitted from the issuer's terminal 12, to the assayer's terminal 13 for a request for the textbook screening.

Next, the assayer (the Minister of Education, Culture, Sports, Science and Technology) assays the content of the textbook data transmitted to the assayer's terminal 13. The assayer approves and grants a certification number with respect to the textbook data to be determined as being recommended for education at school. Then, the assayer transfers the approved textbook data, the certification number, a notice of approval of the textbook screening (notice of approval), using the assayer's terminal 13.

Thereafter, the server 11 transfers the certification number and the notice of approval to the issuer's terminal 12 and stores the approved textbook data in the textbook data storage section 34.

Here, the textbook data stored in the textbook data storage section 34 will be described. Usually, a textbook is organized into a plurality of chapters. In the present system, all of the issuers' textbooks are arranged to have the same number of chapters including the same themes (titles). Therefore, a textbook of each issuer is arranged to have the roughly similar chapters (similar titles), although having specifically different content from each other.

Further, in the present system, with respect to a textbook, a guideline number is given for each chapter. Here, the “guideline” means particulars to be included in the content of each chapter, which are prescribed for each grade and subject by the Ministry of Education, Culture, Sports, Science and Technology. In the present system, a chapter including all of such particulars with respect to a certain textbook is arranged to be given the guideline number. Therefore, all chapters of the textbook having cleared the textbook screening are arranged to have guideline numbers.

Further, in the present system, the textbook data is stored (treated) as a collection of chapters each of which is one data (one data file).

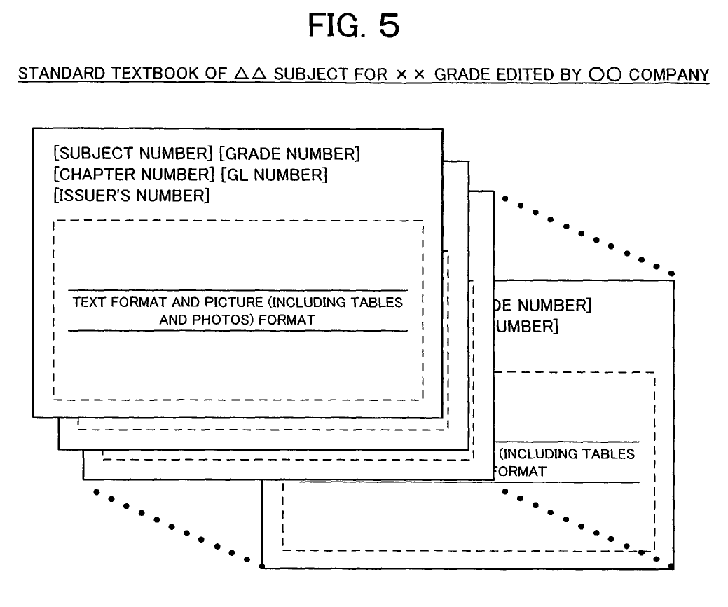

FIG. 5 is an explanatory view of a screen display of the teacher's terminal 14 in browsing the textbook data. As shown in FIG. 5, one window is assigned to each chapter for display of the textbook data.

As shown in FIG. 5, on the top of each window showing each chapter, given are a subject number, a grade number, a chapter number, a guideline (GL) number, and an issuer's number (a number for identifying issuers). It is set so that all contents (text data organizing a chapter and picture data (including tables and photos)) of each chapter can be referred by scroll of the windows.

Note that, hereinafter, data of one chapter making up a textbook data is referred to as “chapter data”.

Next, the following will describe processes (textbook distribution process) related to the browsing of the textbook data in the present system and the creation and sales of the original data.

In the present system, teachers who desire the use of the server 11 (the present system) are members of the present system.

The member records his belongingness and name to the system and pays an annual fee for membership so as to be registered in the present system. Further, in the present system, the teacher as a member is given a log-in ID (ID number (registration number), etc.) and a password.

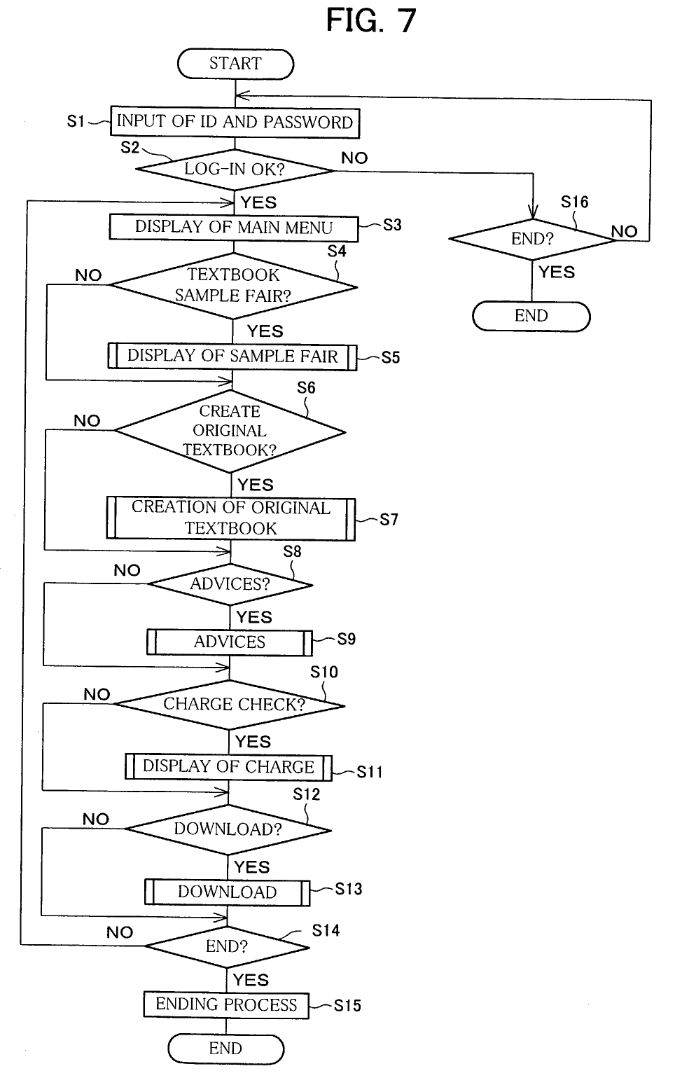

FIG. 7 is an explanatory view showing a flow of textbook distribution process by the server 11.

As shown in FIG. 7, the user of the teacher's terminal 14 accesses to the server 11 and inputs his (or her) log-in ID and password when desiring to carry out processes with the server 11 (S1).

The server 11 checks if the log-in ID and password inputted are registered in the system, and determined whether or not the log-in is permitted (S2). In case where it is determined that the log-in ID and password are not registered, the server 11 informs the teacher's terminal 14 of the fact and asks it whether to finish (whether to finish the log-in to the system) (S16).

On the other hand, in case where it is determined that the log-in ID and the password are registered in the system, the server 11 permits the log-in of the teacher's terminal 14 and displays a main menu to the teacher's terminal 14 (S3).

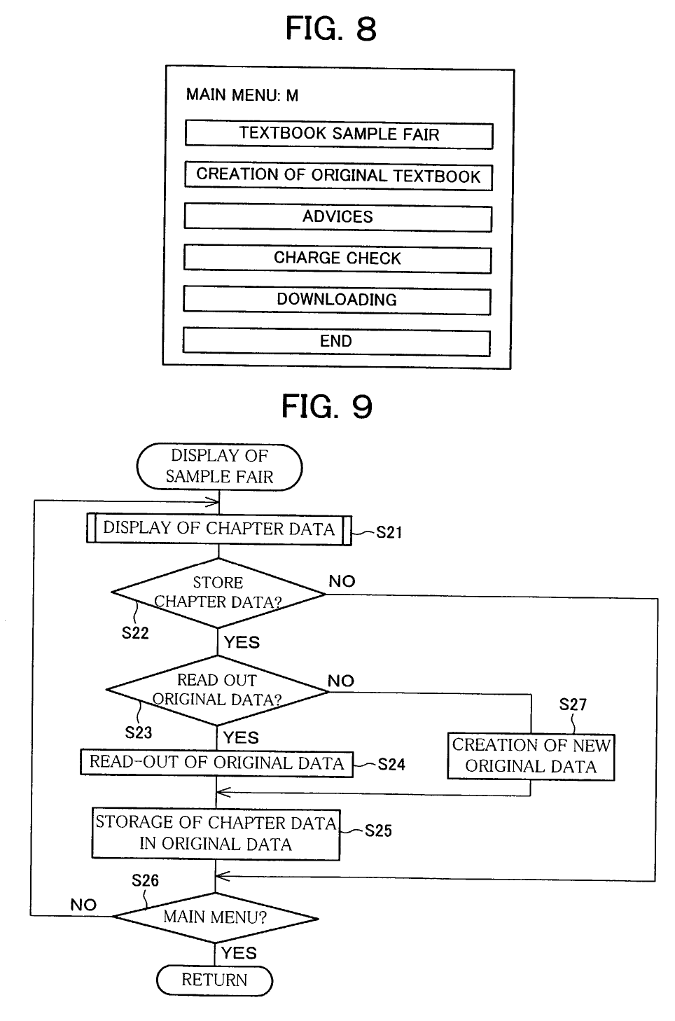

FIG. 8 is an explanatory view showing a main menu displayed on the teacher's terminal 14. As shown in FIG. 8, on the main menu screen is displayed a group of buttons including “textbook sample fair”, “creation of original textbook”, “advice”, “charge check”, “downloading”, and “end”. The user (teacher) of the teacher's terminal 14 can select any buttons in the group of buttons.

The server 11 is set so as to determine whether either of the above buttons is selected (S4, S6, S8, S10, S12, and S14) and to carry out a process in accordance with to the selected button (S5, S7, S9, S11, S13, and S15).

The following will describe respective processes shown in S5, S7, S9, S11, S13, and S15. As described above, in the present system the teacher can create his (or her) own original textbook data (original data). It is set so that the original data in progress of creation can be stored in the client data storage section 36 shown in FIG. 3.

Then, the teacher can create and purchase the original data by carrying out respective processes shown in S5, S7, S9, S11, and S13.

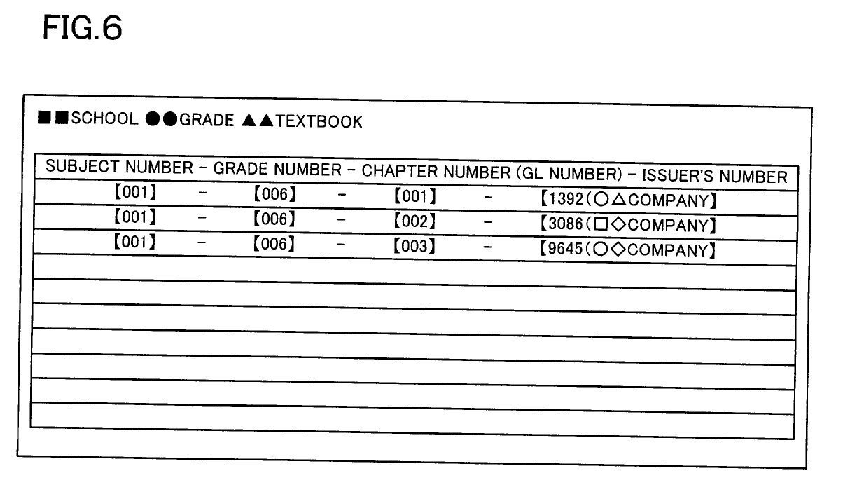

Further, the creation of the original data in the present system is carried out by a combination of several chapter data in each textbook data. FIG. 6 is an explanatory view showing an example of the original data in progress of creation, which is stored in the client data storage section 36.

As shown in FIG. 6, the original data is stored in the form of the list of chapter data specified by the subject number, the grade number, the chapter number (the guideline (GL) number), and the issuer's number. That is, the teacher can examine the content of the chapter data and select the chapter data that he (or she) wants to use so as to create the original data.

The display of the textbook sample fair shown in S5 is a process of disclosing textbook data stored in the textbook data storage section 34 shown in FIG. 3.

Here, as shown in FIG. 5, the textbook data is disclosed (displayed) by textbook data specified by a selection of subjects, grades, and issuers or by chapter data specified by a selection of subjects, grades, chapters, and issuers.

FIG. 9 is an explanatory view showing a flow of operation in case where display by each chapter data is carried out in displaying the textbook sample fair (the display of the textbook sample fair). As shown in FIG. 9, the server 11 carries out the display process of the chapter data (described later) (S21). This displays the chapter data on the display screen of the teacher's terminal 14.

Next, the server 11 asks the teacher's terminal 14 whether the chapter data displayed should be stored or not (S22). When receiving the instruction not to store the chapter data, the server 11 further asks the teacher's terminal 14 whether the main menu or another chapter data should be displayed and displays in accordance with the instruction (S26).

On the other hand, when receiving the instruction to store the displayed chapter data from the teacher's terminal 14, the server 11 waits for the instruction of whether the original data, which is stored in the client data storage section 36, of the user of teacher's terminal 14 should be read out or not (S23).

When receiving the instruction to read out the original data, the server 11 reads out the original data from the client data storage section 36 (S24), and additionally store the chapter data shown in S21 in the original data (S25).

Further, when receiving the instruction not to read out the original data, the server 11 creates new original data for the user (S27), and stores the displayed chapter data in the new original data (S25).

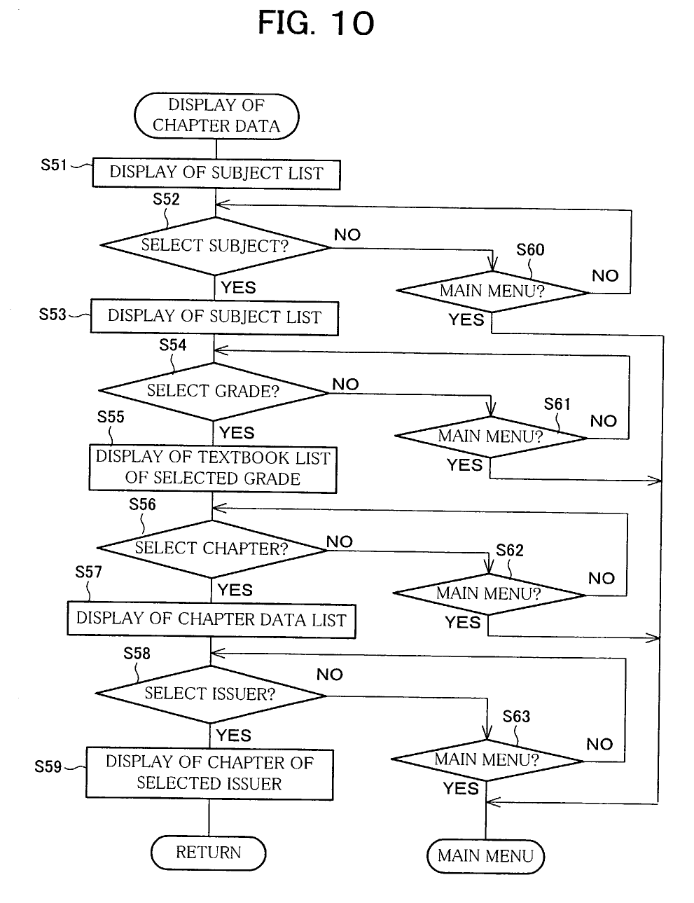

Here, the display process of the chapter data shown as S21 is described. FIG. 10 is an explanatory view showing a flow of the display process of the chapter data. In the display process of the chapter data as shown in FIG. 10, the server 11 displays a list of subjects on the teacher's terminal 14 (S51) so as to make the user of the teacher's terminal 14 to select desired subject, grade, and chapter in this order (S52, S54, and S56).

In accordance with a result of selection by the user, the server 11 displays a textbook list of a selected subject, a textbook list of selected subject and grade, a list (list by issuer) of chapter data of the chapter selected in the textbook of selected subject and grade (S53, S55, and S57). Thereafter, the server 11 receives the result of selection of the issuer (S58) and displays one chapter data selected by the foregoing selection on the teacher's terminal 14 (S59).

Note that, when desiring to stop the display process of the chapter data, the user of the teacher's terminal 14 can turn the display of the teacher's terminal 14 back to the main menu at any steps in the display process (S60 through S63).

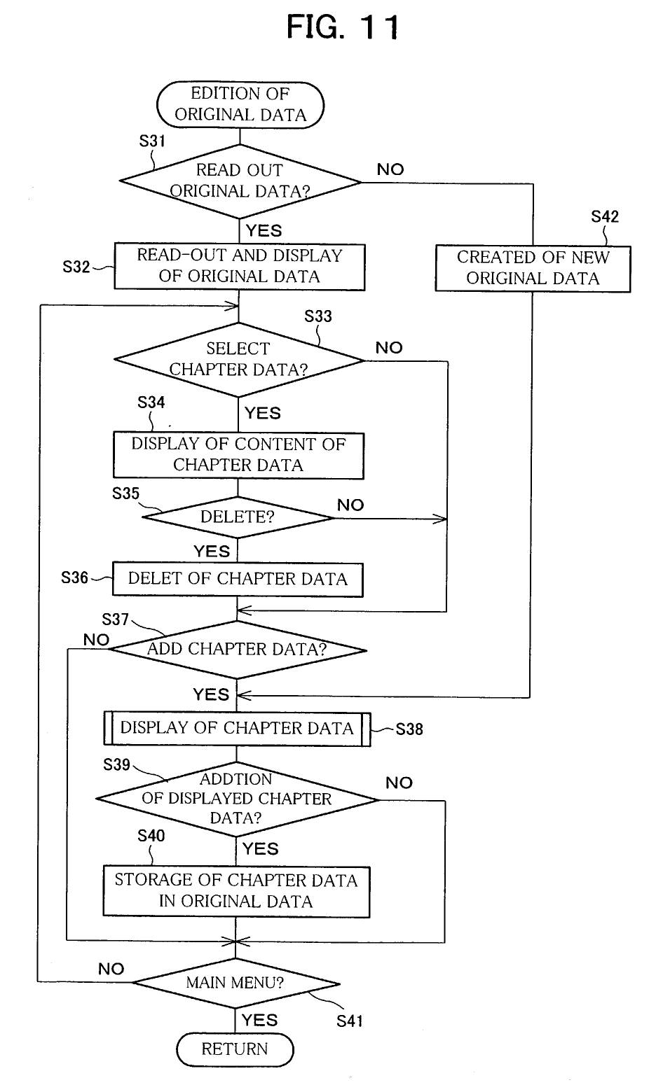

Next, described is editing process of the original data shown as S7 in FIG. 7. FIG. 11 is an explanatory view showing a flow of this process. In the editing process of the original data as shown in FIG. 11, the server 11 waits for the instruction whether to read out the original data of the user of the teacher's terminal 14 stored in the client data storage section 36 (S31).

Then, when receiving the instruction to read out the original data, the server 11 reads out the original data from the client data storage section 36 and displays it on the teacher's terminal 14 in the display style as shown in FIG. 6 (S32).

Thereafter, when receiving from the teacher's terminal 14 the result of the selection (selection with a mouse, etc.) of the chapter data which have been previously stored (listed up) in the original data, the server 11 displays its detailed content (its specific content such as a text and a drawing) on the teacher's terminal 14 (S33 and S34).

Further, when receiving the instruction to delete the displayed chapter data from the teacher's terminal 14, the server 11 deletes the chapter data (S35 and S36).

Further, when receiving the instruction, which is transmitted from the teacher's terminal 14, to add a new chapter data to the original data (S37), the server 11 carries out the display process of the chapter data shown in FIG. 10 and displays a desired chapter data of the user on the teacher's terminal 14 (S38).

Note that, when receiving the instruction not to read out the original data in progress of creation at S31, the server 11 creates new original data for the user (S42) and carries out the display process of S38.

Then, when receiving the instruction, which is transmitted from the teacher's terminal 14, to additionally store the displayed chapter data to the original data (S39), the server 11 additionally stores the chapter data to the original data (S40), and makes the user of the teacher's terminal 14 to select whether to turn the display back to the main menu or to turn back to S33 (S41).

Next, the following will describe the advice process shown as S9 in FIG. 7. The advice process (a guidance/advice process) is a process of judging whether or not the original data created by the user of the teacher's terminal 14 is created in accordance with the guidelines. Further, the advice process includes a step of presenting a class schedule depending on the original data.

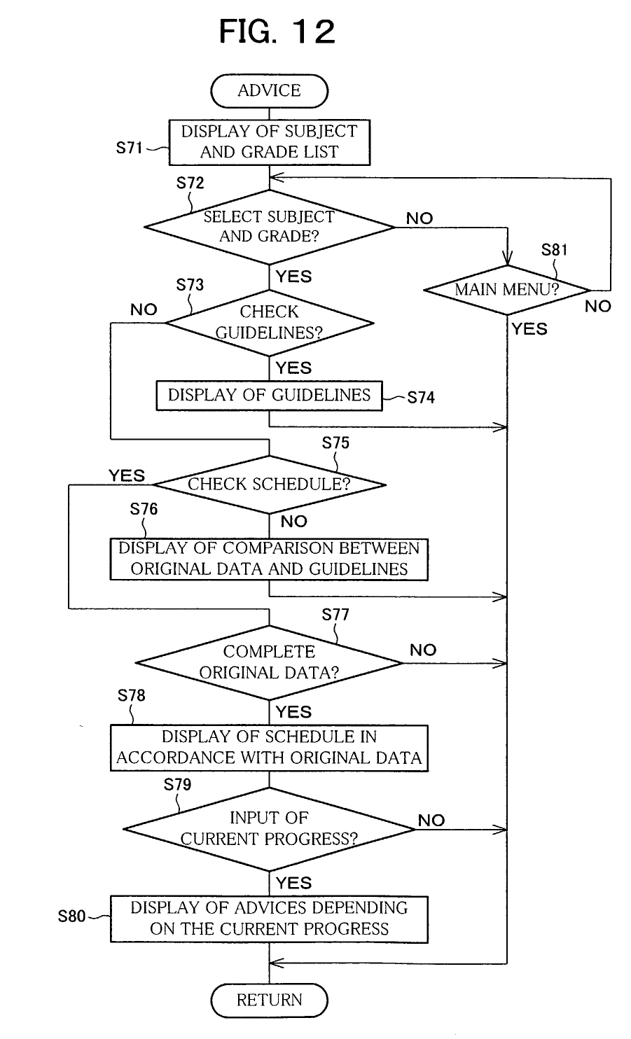

FIG. 12 is a flowchart showing a flow of the advice process. In the advice process as shown in FIG. 12, the server 11 displays a subject list and a grade list on the teacher's terminal 14 (S71). Then, the server 11 waits for the user's selection of the subject and grade (S72). At this point, when receiving the instruction to turn the display back to the main menu, the server 11 turns the display back to the main menu (S81).

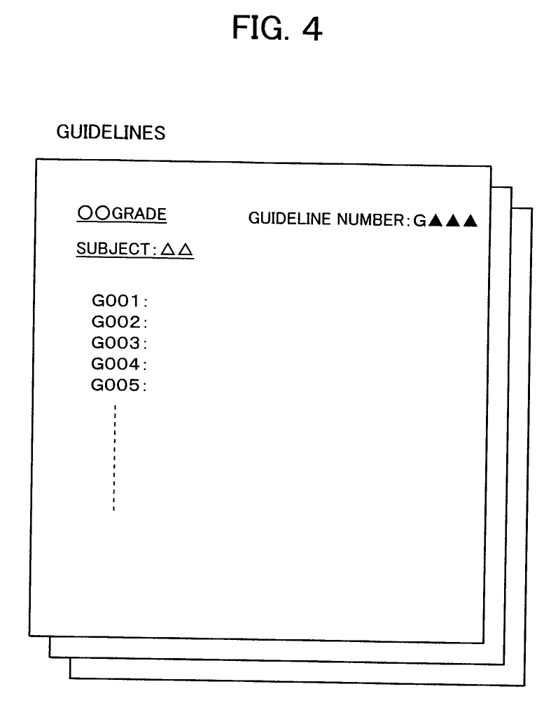

When receiving the result of the selection of the subject and grade, the server 11 asks the teacher's terminal 14 whether to check the guidelines (S73). When receiving the instruction to check the guidelines from the teacher's terminal 14, the server 11 displays the guidelines as shown in FIG. 4 on the teacher's terminal 14 (S74) and turns the display back to the main menu.

Further, when receiving the instruction not to check the guidelines, the server 11 asks the teacher's terminal 14 whether to check a schedule (S75). When receiving the instruction not to check the schedule, the server 11 reads out the user's original data of the teacher's terminal 14 and displays a result of comparison between the original data and the guidelines (S76).

Further, when receiving the instruction to check the schedule, the server 11 asks the user of the teacher's terminal 14 whether the creation of the original data in one volume of book has completed or not (S77). When receiving the reply of not having completed, the server 11 finishes the advice process and turns the display back to the main menu.

On the other hand, when receiving the reply of having completed the original data in one volume of book, the server 11 reads out the user's original data and displays an ideal schedule (a table showing progress on the class) in accordance with the original data (S78).

Thereafter, when receiving the input on current progress on the class using the original data from the teacher's terminal 14 (S79), the server 11 displays advices depending on the current progress on the class (an ideal schedule of a future class, advice on modification of the original data, etc.) (S80), and turns the display back to the main menu.

Note that, it is considered that the process of S74 in FIG. 12 might be used before the creation of original data at a high possibility, and further, the process of S76 might be used during the creation of original data at a highly frequency.

Further, the processes S77 to S80 of the schedule checking are used after the completion of the original data in one volume of book (it may be provisional data).

Next, the following will describe charge display process of S11 shown in FIG. 7. As described previously, in the present system, the teacher as a user of the teacher's terminal 14 can create the original data and store it in the server 11. In downloading such original data to the teacher's terminal 14, the user pays charges corresponding to the content of the original data.

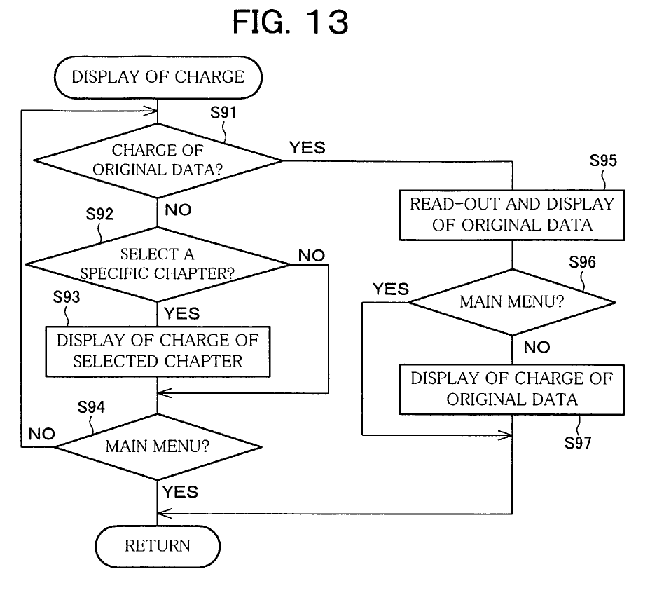

FIG. 13 is a flowchart showing a flow of charge display process. In the process as shown in FIG. 13, the server 11 asks the user of the teacher's terminal 14 whether the charge for the original data or the charge for a specific chapter data in the textbook data should be displayed (S91 and S92).

Then, when being instructed the charge display of the original data, the server 11 reads out the original data of the user from the client data storage section 36 to display it on the teacher's terminal 14 (S95). When receiving no instruction to return to the main menu, the server 11 displays the charge for the original data along with a list of chapter data organizing the original data, and turns the display back to the main menu (S96 and S97).

Further, when receiving the instruction not to display the charge for the original data, and further receiving the result of selection of grade, subject, and chapter, the server 11 displays charge of the chapter data selected in the form of a list by issuer (S92 and S93) and asks the teacher's terminal 14 whether to turn the display of the teacher's terminal 14 back to the main menu (S94). Then, the server 11 turns the display back to the main menu or S91.

Further, downloading process shown as S13 in FIG. 7 is described briefly. When the user of the teacher's terminal 14 selects the button of downloading in the main menu, the server 11 reads out the original data of the user from the client data storage section 36. Then, the server 11 transmits the original data to the teacher's terminal 14.

Note that, this transmission completes the sale of the original data for the user of the teacher's terminal 14. Then, the fee for the sale is charged to each user of the teacher's terminal 14 (or educational institution to which the user belongs) after a lapse of a certain period of time. Further, the server 11 updates the data on the total amount of sales in the ending process shown as S15 in FIG. 7.

As described above, instead of a general distribution (delivery) of a paper textbook, it is set in the textbook distribution of the present system so that the textbook data are shown and distributed (downloaded) to the teacher's terminal 14.

This allows the textbook issuer to show the content of the textbook to the user of the teacher's terminal 14 without printing, binding, and delivering the created textbooks. For the issuer, this makes it possible to prevent the production of the textbook which might not be used in the end.

Further, especially in the present system, it is set so that in response to the instruction supplied from the teacher's terminal 14, the server 11 creates an original textbook data by a combination of a plurality of textbook data stored therein and distributes the original textbook data to the teacher's terminal 14.

This allows the user of the teacher's terminal 14 to create and obtain his own (original) textbook data, using the ready-made textbook data. Therefore, the users of the teacher's terminal 14 can create a suitable textbook data depending on use conditions (for example, the number and an academic ability of students who the users teach, and hours of teaching).

Further, in the present system, the textbook data is a collection of chapter data corresponding to chapters which organize a textbook. The user of the teacher's terminal 14 can select desired chapter data in each textbook data and transfer the selected chapter data to the server 11. It is set so that the server 11 can select the chapter data from the textbook data in response to the instruction transmitted from the teacher's terminal 14 to incorporate it into the original data. This makes it possible to create the original data quite easily.

Further, in the present system, the server 11 can judge suitability of the original data created in response to the instruction by the teacher's terminal 14 (whether the original data satisfy the guideline's requirements). This makes it possible to suppress the creation of improper original data.

Still further, it is set in the present system so that the server 11 receives the textbook data transmitted from the issuer's terminal 12 and stores them therein. This makes it possible to prevent the issuer of the textbook data from visiting the place where the server 11 is installed.

Further, the server 11 is set so as to transmit to the assayer's terminal 13 the textbook data transmitted from the issuer's terminal 12 and to store in the storage section only textbook data which are assayed and approved by the assayer's terminal 13.

For the issuer, this makes it possible to transfer to the assayer the textbook required for textbook screening in the form of textbook data via the server 11. Therefore, no necessity of binding and delivering the textbook for textbook screening can accelerate the process of textbook screening. Further, only by taking a report of the result of textbook screening, it is possible to set the server 11 so as to be able to distribute the approved textbook data to the teacher's terminal 14, thereby quickly distributing the textbook data after textbook screening.

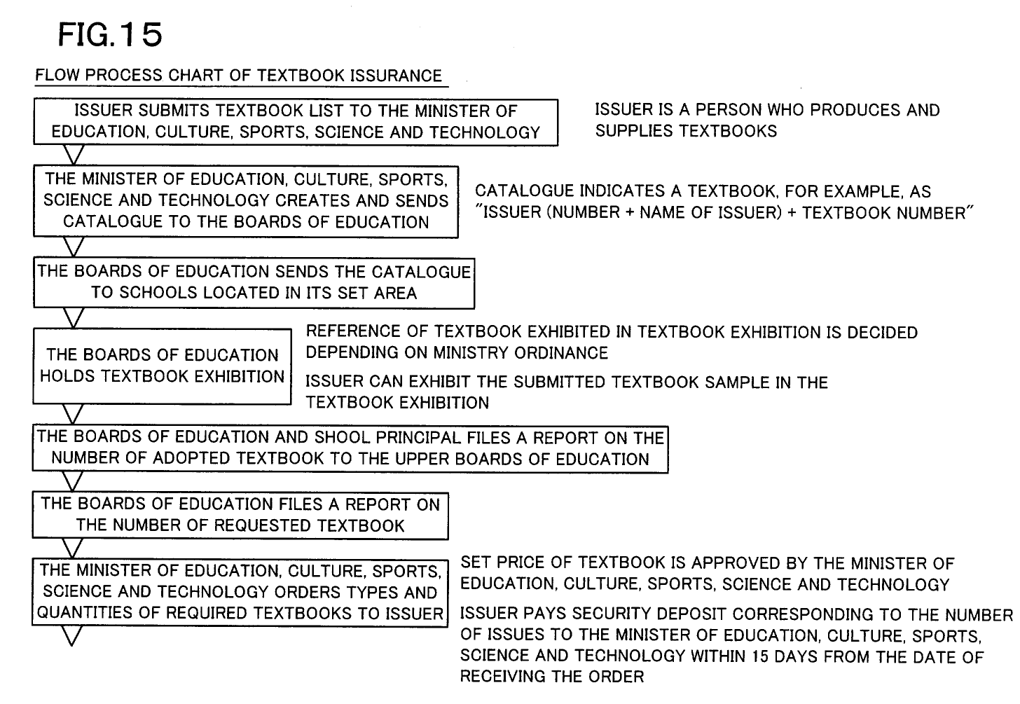

Note that, according to the process shown in FIG. 15, three to four years has been taken from the end of the textbook's creation by the issuer to the actual use of the textbook (to the supply to children and students). This brings the problem that the content of the textbook cannot catch up with quickly changing times.

Further, according to the process shown in FIG. 15, it is necessary for the issuer to secure a wide space (a space for storage) for distribution (for storage and transport of textbooks as a book. In contrast, in the present system, processes of textbook screening, presentation of the content of the textbook, and sales of textbooks are carried out by transmission and reception of the textbook data as electronic data. This makes it possible to dramatically improve the distribution speed as well as to reduce equipments and costs required for distribution, as compared with the case of distribution of the paper textbook.

Next, described is the use of the original data created by each teacher.

As shown in FIG. 1, the teacher's terminal 14 is connected via a network to a plurality of student's terminals 15.

The student's terminal (learner's apparatus) 15, which includes an HD (storage device) 25 as shown in FIG. 2, a CPU (control device) 26, a display device (display screen) 22, RAM 24, and an input device 21, is a portable display device (viewer; digital paper) which is easy to carry.

The student's terminal 15 downloads and stores a plurality of original data created by each subject from the teacher's terminal 14, and the content of the original data can be displayed on the display screen of the student's terminal 15 in response to the instructions by the user (children and students).

In the present system, one student's terminal 15 is distributed for each children or each student. The original data is stored under the responsibility of each school or each teacher, and it is set so that the original data is downloaded to the student's terminal 15, if necessary.

Note that, the student's terminal 15 is set so that the original data stored inside can be displayed, but the stored data cannot be modified. That is, the teacher's terminal 15 is an apparatus exclusively used for display to display the original data.

Thus, in the present system, instead of using paper textbook, the present system can display the content of the textbook (the content of the original data) by using the student's terminal 15. That is, it is set so as to use the student's terminal 15 as a textbook.

This allows children and students to arrive and leave school just only with one student's terminal 15 even if they have a plurality of classes. This can extremely reduce physical fatigue of children and students, as compared with the case of walking with a plurality of paper textbooks.

Further, the children and students can dispose of textbooks only by deleting the textbook data stored in the student's terminal 15. This can decrease the trouble of disposing process, as compared with the case of using the paper textbook.

Still further, in the present system, the user (teacher) of the teacher's terminal 14 may change the content of the original data to be stored in the student's terminal 15, depending on the progress on classes. That is, it is preferable to modify (arrange) the original data as a textbook for increase in efficiency of class progress.

In such a case, the user of the teacher's terminal 14 edits and re-downloads the original data stored in the client data storage section 36 of the server 11 by editing process of the original data, which is shown in FIG. 10.

Further, it is not necessary to make all children and students to store the same original data in their student's terminals 15. That is, the content of the original data given to the children and students may be changed depending on levels in learning of children and students.

This enables children and students to carry out the learning according on their academic abilities. For example, chapter data having an advanced content or original data including chapter data for next grade is given to children and students having a high level of speed in learning, so that it is possible to increase the efficiency of learning. Meanwhile, the original data including the chapter data that has been already learned is given to children and students having a low level of speed in learning, so that it is possible to carry out the secure learning by review. This enables children and students to carry out the learning according to their academic abilities (learning speeds), and it is possible for children and students to take classes with pleasure.

Further, it is preferable that the student's terminal 15 can connect to the Internet 5. In such a case, it is preferable that the user of the teacher's terminal 14 makes the original data to have links to general homepages in creating original data. For children and students, this makes it easy to learn more deeply about the content of the textbook or to search for related matters.

Further, the student's terminal 15 may be arranged so as to store materials to be added to the content of the original data or textbook data (original data) for next grade or previous grade. This makes it easy to carry out more deep learning, and preparation and review.

Further, it is preferable that the original data stored in the student's terminal 15 is set so as not to be rewritten on the student's terminal 15.

This is designed to prevent the children and students from doodling on the original data or erasing the original data, to allow teachers to grasp the children and students' progress in learning, and not to disturb the progress of the class based on the guidelines.

Further, as the student's terminal 15, for example, various display devices including a memory may be adopted. Further, adoption of the display device without a CD-R device can reduce the size and weight of the student's terminal 15.

Still further, the display screen provided in the student's terminal 15 is preferably a display such as a reflective LCD (Liquid Crystal Display) panel, an EL (Electroluminescence) display, an electrophoretic display or a twisting ball display, which is suitable for a small-sized display device.

Yet further, it is preferable that the display screen is a reflective display panel having memory effect. The display panel having memory effect can perform long hours of display without fear of battery exhaustion. Further, a reflective display panel can reduce electric power consumption and display images as pictures painted on the paper. That is, it is easy for children and students to understand what the textbook data shows.

Further, in the present system, the original data downloaded once to the teacher's terminal 14 may be arranged so as to be edited by the teacher's terminal 14 or other apparatus in the educational institution. In such a case, it is preferable that the user of the teacher's terminal 14 (or other apparatus) is limited to teachers. Further, it may be set so as to carry out identification by an ID number or a password in order to limit a person who performs such an edition.

Further, the teacher's terminal 14 may be arranged so as to include a protective device (security system) to prevent the original data stored in the teacher's terminal 14 from being modified in vain. In such a protective device, for example, a technique of Japanese Laid-Open Patent Publication No. 215274/1994 (Tokukaihei 6-215274, published on Aug. 5, 1994) can be used. In the technique, it is set so that data edition is possible only in case where the contents of a removable security memory and a last mode memory to be stored in the main body coincide with each other. According to this technique, management of the security memory by teachers or a specified manager can control modification of the original data.

Also, as a protective device, a technique of Japanese Utility Model Application Laid-Open Publication No. 95488/1990 (Jitsukaihei 2-95488, published on Jul. 30, 1990) can be used. In the technique, it is set so that a locking part attached at the modular part which is capable of data communication can prohibit data modification mechanically. Removal of the locking part by a special removing equipment is required for data modification. Therefore, installation of the removing equipment, for example, at the backroom of teachers' office can discourage data modification by outsiders, children, and students.

Further, in the present system, the content of chapter data organizing textbook data may be set so as not to be modified even by the teacher's terminal 14. This makes it easy to follow the textbook screening system and to protect copyright.

Still further, in the present embodiment, the teacher as a user of the teacher's terminal 14 makes an access (log in) to the server 11. However, it is preferable that the textbook data (ready-made textbook) stored in the textbook data storage section 34 of the server 11 is set so as to be freely referred to on the Internet 5. This allows people which are not limited to teachers to refer to the authorized textbook data.

Yet further, in such a case, it is preferable that persons who are permitted to download the textbook data (the textbook data exhibited at the textbook sample fair) are limited to members of the present system.

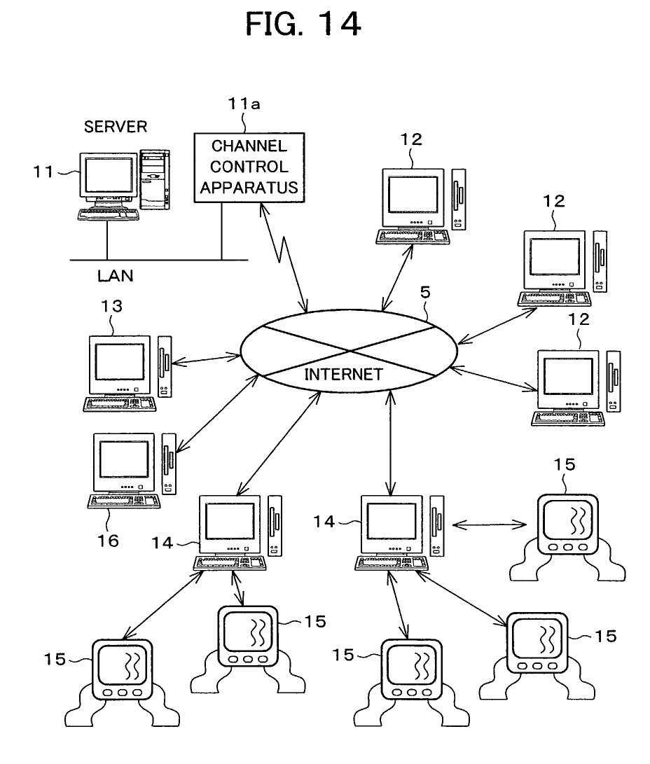

Further, such a rule may be established that non-teachers can enroll as members of the present system. For example, a general person (learner) who wants to be a member may be a member when providing a part of personal information (belongingness, credit card number, etc.) to the present system and passing an inquiry into a financial status and a check on solvency. In such a case, as shown in FIG. 14, a learner's terminal (a receiver's terminal) 16, which has a capability similar to the teacher's terminal 14, is added to the present system.

Here, the following will describe a membership fee of the present system and costs for purchase of the original data (textbook data).

In the present system, a member (or an educational institution which the member belongs to) pays fees for purchase corresponding to the amount of the original data (or the ready-made textbook data) which has been downloaded (purchased) (or fees corresponding to the number of times of downloading), in addition to a membership fee (an annual fee for membership) at regular intervals.

Note that, the fees for purchase may be set so as to correspond to the number of chapter data included in the downloaded original data (textbook data). Further, the annual fee for membership and the fees for purchase may be set so as to correspond to the number of children and students or the number of teachers in the educational institution which the member belongs to.

Further, the amount of data permitted to be downloaded, the number of times of downloading, or the number of chapter data may be limited depending on the amount of membership fee.

Still further, the fees for purchase and the membership fee may be discounted for educationalists, especially members who create textbook for children and students under compulsory education because they download many times and the large amount of data.

Yet further, in the present system, the number of times of downloading chapter data in each textbook data is totaled at a predetermined date such as at the end of the year or at the end of the fiscal year. An amount of charge corresponding to totaled numbers is paid to the issuer as a creator of textbook data.

Further, at the end of the year or at the end of the fiscal year, an amount of charge corresponding to the number of times of downloading may be settled up from the annual fee for membership or a part of the annual fee uniformly that has been paid in advance to each issuer.

Further, in order to count the number of times of downloading, a technique (a technique of confirming the presence of a rewrite-inhibited fixed data and recording in a nonvolatile manner) of Japanese Laid-Open Patent Publication No. 116493/1998 (Tokukaihei 10-116493, published on May 6, 1998), and a technique (a technique of providing a non-receptible counter for counting the writing frequency to the flush memory in which the change and set of the count value is impossible) of Japanese Laid-Open Patent Publication No. 43199/1995 (Tokukaihei 7-43199, published on Feb. 10, 1995) may be used.

Further, it is preferable that the children and students rent the student's terminals 15. In such a case, the children and students return the student's terminals 15 on their graduation. The student's terminal 15 may be rented from the present system (server 11) to each educational institution (or children and students). In renting the student's terminal 15, it is preferable to replace the damaged or broken student's terminal 15 with new one and to demand a compensation for willful destruction of the student's terminal 15.

Further, in the present embodiment, the teacher creates the original data. However, the present invention is not limited to this, and the original textbook may be created by a person in charge in a school, a school district, or a prefecture as a unity.

Still further, in the present embodiment, the user of the teacher's terminal 14 downloads the original data from the server 11 to the teacher's terminal 14, and uses the data in his class, letting his students download the data to the student's terminal 15. However, the present invention is not limited this, and it may be arranged to make the boards of education or a school principal to check whether the original data is suitable for education before the children and students download the original data from the teacher's terminal 14. In such a case, it is preferable to use the original data in class after approval of the original data by the boards of education or the school principal.

Further, in the present embodiment, the user (teacher) of the teacher's terminal 14 creates the original data using the server 11. However, the present invention is limited to this, and the user of the teacher's terminal 14 may purchase (download) the textbook data as it is transmitted from the issuer's terminal 12 to the server 11.

In such a case, all chapter data in one textbook data may be selected so as to organize the original data. In the downloading process shown as S13 in FIG. 7, a specified textbook data stored in the textbook data storage section 34 may be downloaded.

Therefore, the textbook distribution apparatus of the present invention (the server 11 of the present system) can be expressed as such a textbook distribution apparatus for distributing textbooks to educational institutions includes: a storage section for storing the textbook data; and a control section for transmitting the textbook data to an external receiver's terminal in response to an instruction which is supplied from the external receiver's terminal.

Further, in the present embodiment, the teacher's terminal 14 is installed at educational institutions such as an elementary school and a junior high school. As examples of such educational institutions other than the elementary school and the junior high school, given are a nursery school, a kindergarten, a school for disabled children, a high school, a university, a graduate school, a private preparatory school, a private school for entrance into a college or university, a technical school, a juvenile detention facility, a culture school, a senior college, etc.

Further, in case where the present system is applied to educational system using a textbook which requires no textbook screening, the assayer's terminal 13 is not required.

Still further, in the present embodiment, a guideline number is given to each chapter data. However, the invention is not limited to this. Instead, the guideline number may be given to each paragraph, each text data, or each picture data.

Further, the present system may be set so that the content of the chapter data in the original data copied to the client data storage section 36 can be modified by the teacher's terminal 14. The extent (limitation) of such modification is either the reordering of text data and picture data which organize one chapter data or the interchanging (exchange with text data and picture data of other chapter data) text data and picture data which organize the chapter data.

In such a case, it is preferable to give a guideline number to each text data and picture data, and to create the original data so as to collect specified all guideline numbers.

Further, in the present embodiment, transmission and reception of the textbook data are carried out via the server 11 between the issuer's terminal 12 and the assayer's terminal 13 on the occasion of the screening of the textbook data created by the issuer. However, the invention is not limited to this, and it may be arranged to directly transmit and receive the textbook data between the issuer's terminal 12 and the assayer's terminal 13.

In such a case, the issuer computerizes (digitalizes) the content of the textbook to create textbook data (electronic textbook). Then, using the issuer's terminal 12, the issuer transmits the textbook data via the Internet 5 to the assayer's terminal 13 to request for the textbook screening. The assayer (the Minister of Education, Culture, Sports, Science and Technology) examines the content of the textbook data transmitted to the assayer's terminal 13. Then, when approving the textbook data is suitable for the use in the school education, the assayer grants the textbook data the certification number. Then, using the assayer's terminal 13, the assayer informs the issuer's terminal 12 of the certification number and the approval. Using the assayer's terminal 13, the assayer transmits to the server 11 the textbook data which is given the certification number.

In the present embodiment, the teacher makes the student's terminal 15 to store the original data which have been downloaded to the teacher's terminal 14 so as to use the student's terminal 15 as a textbook. However, the present invention is not limited to this, and the user (teacher) of the teacher's terminal 14 may print and bind the original data which have been downloaded to the teacher's terminal 14 to distribute his students as a textbook.

In the present embodiment, the server 11 creates the original data based on the textbook data by subject and grade. However, the present invention is not limited to this, and one original data may be created by a mixture of chapter data on a plurality of subjects and grades.

Further, in the present embodiment, the issuer digitalizes the content of the textbook and creates the textbook data equivalent to a textbook in one volume; however, the creation of a partial textbook data (the creation of a part of data in the textbook) may be adopted. In such a case, the user of the teacher's terminal 14 picks out required parts from the partial textbook data and makes an instruction to create the original data.

In the present embodiment, described is the case of using a current Japanese school textbook. However, the invention is not limited to this, and it is applicable to the textbook in educational institutions such as a private preparatory school. Except for the textbook screening system, the present invention can be adopted in foreign countries. Further, it is possible for general people who desire to study to purchase textbook data, and the textbook data can be a good material for lifelong education.

Further, in case where the textbook creation is carried out in the system with no textbook screening system (for example, in the private preparatory school), it is preferable that the teacher's terminal 14 (server 11) edits the copied textbook data freely (without limitation) in response to the instruction of the user (teacher) so as to create the original data.

In the present system, the distribution of the textbook sample is not necessary. With this, the present system is effective especially in the case of a large cost for the distribution (in case of management of the textbook distribution in a vast area (land) or an area of undeveloped transportation).

Further, in the present embodiment, the present system is used as a system for textbook distribution. However, the present invention is not limited to this, and the present system is applicable to any systems in which it is preferable to access from a terminal such as the teacher's terminal 14 to the server 11 and to create and distribute the original data by a combination of ready-made data stored in the storage device of the server 11.

That is, the present invention can be also expressed as a first distribution apparatus which includes a storage section for storing ready-made data and a control section for creating combined data by a combination of a plurality of ready-made data in accordance with an instruction supplied from a receiver's terminal and for distributing combined data thus created to the receiver's terminal.

The first distribution apparatus is an apparatus for distributing combined data to predetermined places including educational institutions, a general household, a shop and a company. Here, the ready-made data is made up of information which is prepared by a creator of data, for example, such as album data including a plurality of music data (the creator is a recording label), telephone directory data including names, addresses, telephone numbers, etc. of habitants in each area (the creator is a telecommunications company), data of book (the creator is a publishing company, or a writer).

The first distribution apparatus is set so that the control section creates an original combined data by a combination of a plurality of ready-made data stored in the storage section in response to the instruction which is supplied from the receiver's terminal, and distributes the created original combined data.

Here, the combined data is electronic data which is used publicly or personally by the user of the receiver's terminal.

Also, “a combination of ready-made data” means to pick out from each ready-made data smaller units (for example, music data in one volume) of data which organize the ready-made data and to collect them.

This allows the users of the receiver's terminal to create and obtain their own (original) combined data using the ready-made data.

Further, in case where the ready-made data is data of book, the user of the receiver's terminal can obtain their original book (data) by picking out and combining preferable parts from a ready-made book. Note that, in such a case, it is preferable that the first distribution apparatus charges a sum corresponding to the amounts and types of the ready-made data used for combination to the user of the receiver's terminal.

Note that, Japanese Laid-Open Patent Publication No. 2000-250393 (Tokukai 2000-250393, published on Sep. 14, 2000) discloses a system of transmitting and receiving teaching materials (textbooks and test papers) via a network with teacher's and student's computers. In the system, it is set so that a teacher can modify the content of teaching materials for use in accordance with an understanding degree of each student.

However, since the system shown in the above publication is one for distributing teaching materials in accordance with the understanding degree of each student, it is usually impossible to arrange the content of the teaching material in accordance with the guidelines (a curriculum prescribed by the boards of education, etc.). Therefore, it is not preferable that the teaching material in the above system is applied to usual school classes as a substitution for the paper textbook.

Further, the student's computer in the system is not a portable apparatus. Because of this, it has been impossible to use the above system in the educational institutions taking a form of commuting from home to school.

Still further, in the present system, the textbook distribution process by the server 11 is carried out by control operation of the control section 38 as a center of the server 11. However, the present invention is not limited to this, and instead of the control section 38, an information processor which can read out a program, which is recorded in a recording medium, for carrying out textbook distribution process may be used.

In this arrangement, calculating apparatus (CPU and MPU) of the information processor reads out the program recorded in the recording medium and executes the textbook distribution process. The program itself therefore realizes the textbook distribution process.

Here, as the above information processor, a function expansion board and a function expansion unit which are fixed to a computer can be used other than general computers (a work station and a personal computer).

Further, the above program is program codes (object program, intermediate code program, source program, etc.) of software to realize the textbook distribution process. The program may be used singly or in combination with other program (OS, etc.). The program may be one which is once stored in a memory (RAM, etc.) inside the apparatus after being read out from the recording medium and is read out again to be executed.

Further, the recording medium for recording the program may be one which can be divided easily from the information processor or one that is fixed (applied) to the apparatus. Further, the recording medium may be one which is connected to the apparatus as an external storage.

As such a recording medium, applicable are a magnetic tape such as a video tape and a cassette tape, a magnetic disk such as a floppy disk and a hard disk, an optical disk (magneto-optical disk) such as CD-ROM, MO, MD, DVD, and CD-R, a memory card such as an IC card and an optical card, and a semiconductor memory such as a mask ROM, an EPROM, an EEPROM, and a flash ROM.

Further, also applicable is a recording medium connected via a network (Intranet, Internet, etc.) to an information processor. In such a case, the information processor obtains a program by downloading via a network. That is, the above program may be arranged so as to be obtained via a transmission medium (a medium holding a program movably) such as a network (wired or wireless connection). Note that, it is preferable that the program for downloading is stored in advance in the apparatus.

Further, the textbook distribution apparatus of the present invention can be also expressed as a textbook distribution apparatus for distributing a textbook to a predetermined receiver, which includes: a storage section for storing a plurality kinds of textbook data; and a control section for creating an original textbook data by a combination of a plurality of textbook data and for distributing the original textbook data thus created to the receiver's terminal in response to an instruction which is supplied from the external receiver's terminal.

As described above, the textbook distribution apparatus of the present invention (the present distribution apparatus) for distributing a textbook to a predetermined receiver, includes: a storage section for storing a plurality of textbook data; and a control section for distributing the textbook data stored in the storage section to an external receiver's terminal in response to an instruction which is supplied from the external receiver's terminal, wherein the control section is set so as to create an original textbook data by a combination of the plurality of textbook data in response to an instruction which is supplied from a receiver's terminal and to distribute an original textbook data thus created to the receiver's terminal.

The present distribution apparatus is an apparatus for distributing textbooks to predetermined places including educational institutions such as an elementary school, a junior high school, and a private preparatory school, a general household, and a company.

Here, the textbook as described above means a reading book for use in classes of the educational institutions or for the purpose of a self-study. Further, the textbook data means computerized content of the textbook.

Instead of a general distribution (delivery) of a paper textbook, textbook distribution in the present distribution apparatus is set so that the textbook data are distributed to a terminal installed at a receiver's place (a receiver's terminal). That is, in the present distribution apparatus, the above textbook data are stored in the storage section so as to be distributed in response to a request from the receiver's terminal.

This allows the textbook issuer to distribute a textbook without printing, binding, and delivering the created textbooks, only by storing the textbook data in the present distribution apparatus.

Therefore, the textbook issuer can show the content of the textbook without printing to users (educationalists, etc.) of the receiver's terminal. For the issuer, this makes it possible to prevent the production of the textbook which might not be used in the end.

Further, especially, the present distribution apparatus is set so that the control section creates an original textbook data by a combination of a plurality of textbook data stored in the storage section in accordance with the instruction which is supplied from the receiver's terminal, and it distributes the created original textbook data to the receiver's terminal.

Here, “a combination of textbook data” means to pick out from each textbook data smaller units of data (for example, chapter, item, etc.) which organize the textbook data and to collect them.

According to the present distribution apparatus, this allows the users of the receiver's terminal to create and obtain their own (original) textbook data, using ready-made textbook data.

Therefore, the users of the receiver's terminal can create a suitable textbook data depending on use conditions (for example, the number or an academic ability of students who the users teach).

Note that, in case where the textbook data is a collection of chapter data corresponding to chapters which organize a textbook, it is preferable that the user of the receiver's terminal selects desired chapter data in each textbook data and transfers the selected chapter data to the present distribution apparatus. Also, it is preferable that the control section of the present distribution apparatus is set so as to select the chapter data from the textbook data in response to the instruction transmitted from the receiver's terminal to incorporate it into the original textbook data. This makes it possible to quite easily create the original textbook data.

Further, it is preferable that the control section is set so as to judge whether the original textbook data created in response to the instruction which is transmitted from the receiver's terminal includes all particulars prescribed as the content of the textbook.

Such a judgment is carried out by comparison between the content of the original textbook data and teaching guidelines (guidelines) prescribed by public institutions (the boards of education, the Ministry of Education, Culture, Sports, Science and Technology, etc.). This makes it possible to prevent the original textbook data from being far from prescription of the guidelines.

Further, it is preferable that the control section receives the textbook data transmitted from the external issuer's terminal and stores them in the storage section.

This makes it possible to prevent the issuer of the textbook data from visiting the place where the present distribution apparatus is installed, thereby making it easy to store the textbook data in the storage section of the present distribution apparatus.

Still further, in case of distributing a textbook required for textbook screening in advance, it is preferable that the control section is set so as to transmit textbook data from the issuer's terminal to the external assayer's terminal and to store in the storage section only textbook data which are assayed and approved by the assayer's terminal.

Here, the assayer's terminal is a terminal unit used by the assayer who assays textbooks. In the arrangement, the issuer can transfer to the assayer the textbook required for textbook screening in the form of textbook data via the present distribution apparatus. Therefore, no necessity of binding and delivering the textbook for textbook screening can accelerate the process of textbook screening. Further, only by taking a report of the result of textbook screening, it is possible to set the present distribution apparatus so as to be able to distribute the approved textbook data to the receiver's terminal, thereby quickly distributing the textbook data after textbook screening.

Further, by a combination of the present distribution apparatus, the issuer's terminal which transmits the textbook data to the present distribution apparatus, and the receiver's terminal which transmits the instruction to the present distribution apparatus, it is possible to prevent the issuer from printing and binding textbooks. Still further, it is possible to build a textbook distribution system which can distribute the original textbook data to the receiver's terminal.

Further, a textbook distributing method of the present invention for distributing a textbook to a predetermined receiver, includes the steps of: (a) storing a plurality of textbook data in a storage section of a textbook distribution apparatus; (b) creating an original textbook data by a combination of the plurality of textbook data in response to an instruction supplied from an external receiver's terminal; and (c) distributing an original textbook data thus created to the receiver's terminal, the steps (a) through (c) being executed by a control section of the textbook distribution apparatus.

This distribution method is a method used in the present distribution apparatus. Therefore, by using the method, it is possible to prevent the issuer from printing and binding of textbooks, and to distribute the original textbook data to the receiver's terminal.

Further, in a textbook distribution program of the present invention, a computer capable of transmitting and receiving data with outside is functioned as a control section in the present textbook distribution apparatus.

Also, the textbook distribution program of the present invention can be expressed as a program for making the computer capable of transmitting and receiving data with an external apparatus to execute a storing step, a creating step, and a distributing step in the above textbook distribution method.

It is possible to realize the processing of the present distribution apparatus (or the above textbook distribution method) by the computer, which is capable of transmitting and receiving data, reading out the program.

Further, recording the program in the computer-readable recording medium enables easy storage and distribution of the program. Still further, reading the recording medium into the computer which can transmit and receive data enables processing of the present distribution apparatus (or the above textbook distribution method).

Further, in a textbook display system of the present invention in an educational institution, a learner's apparatus is provided for storing textbook data obtained from an external apparatus and for displaying textbook data thus obtained in response to an instruction supplied from a learner, the learner's apparatus being a portable apparatus.

The system is used for displaying (disclosing) the content of the textbook to learners (children and students) in the educational institutions such as an elementary school, a junior high school, or a private preparatory school. That is, the system is arranged so that the learner's apparatus stores the textbook data as described above, instead of a general paper textbook, and displays the content of the textbook data.

This reduces the consumption of paper materials. Further, it is possible to dispose of textbooks only by deleting the textbook data stored in the learner's apparatus, thereby decreasing the trouble of disposing process, as compared with the case of using the paper textbook.

Further, it is possible to refer to the content of a plurality of textbooks with one apparatus by storage of a plurality of textbook data (textbook data involved in a plurality of subjects) in the learner's apparatus, thereby stopping the intricacies involved in learning.

Further, in the system, the learner's apparatus is a portable apparatus. Therefore, since the learners can attend and leave school just only with one learner's apparatus, they can learn with one learner's apparatus both at educational institutions and their home. In case of storing the plurality of textbook data in the learner's apparatus, it is possible to reduce physical fatigue of the learners, as compared with the case of walking with a plurality of paper textbooks.

Further, the learner's apparatus may have an arrangement in which the textbook data stored in the storage section cannot be modified. This makes it possible to prevent unnecessary (or improper) modification of the textbook data by the learners.

Still further, it is preferable that the display screen provided in the learner's apparatus is a display such as a reflective LCD (Liquid Crystal Display) panel, an EL (Electroluminescence) display, an electrophoretic display or a twisting ball display, which is suitable for a small-sized display device.

Yet further, it is preferable that the display screen is a reflective display panel having memory effect. The display panel having memory effect can perform long hours of display without fear of battery exhaustion. Further, a reflective display panel can reduce electric power consumption and display images as pictures painted on the paper. That is, it is easy for learners to understand what the textbook data shows.

Note that, there are the following concerns about the paper textbook. That is, it is necessary for children and students to carry textbooks for each subject; therefore, they arrive school everyday with several textbooks of subjects which are planed to use in classes. It is necessary for children and students to carry one whole textbook only for learning a limited part in the textbook for the day. In other words, children and students are obliged to arrive school everyday carrying a heavy baggage with physical fatigue. Further, a teacher conducts classes for the day with textbooks effectively by using methods of distributing documents related to classes all together to children and students. Further, classes have been conducted at an even speed to all children and students without consideration of levels in learning of children and students. Note that, the contents of bound textbooks are impossible to be rewritten; therefore, it is possible for children and students to surely do lessons in accordance with the textbook screening. Further, used textbooks are basically disposed. Recently, the used textbooks have been included in a flow of collection and recycle of used papers. However, enormous amount of energy has been required for recycling the used textbooks.

Further, the client data storage section 36 may be arranged to store data (files) on educationalists (school, private preparatory school, etc.), data on teachers, children, and students, and data on the number times of downloading textbook data. Still further, the main program storage section 33 may be arranged to store a program for displaying a guidance screen, a program for displaying a textbook sample fair, a search program, and program for creating a virtual textbook (original data). Yet further, the textbook data storage section 34 may be arranged to store data on textbook list.

Further, upon display of textbook data on the teacher's terminal 14, the teacher's terminal 14 may be arranged to display not by each chapter, but by each text data and each picture data (data of illustrations, tables, photos, etc.) organizing a chapter. In such a case, a window is allocated for each text data and each picture data. Still further, a subject number, a guideline number, a certification number, an issuer's number, a text number, and a picture number may be given on the top of the window.

Further, in the present invention, the computerized (digitalized) textbook, not using a conventional paper textbook, can shorten the period until the textbook screening is carried out, make it easy to correct its content, and present its sample to the boards of education and schools. Therefore, there is no necessity of binding, and preparation of special place and means for storing and transporting textbooks is not necessary. Also, disposing process is carried out only by deleting data, without the consumption of large amount of energy.

The textbook may be organized roughly by chapters in accordance with the teaching guidelines (or guidelines) decided by the Ministry of Education, Culture, Sports, Science and Technology. In creating a textbook, the issuer may create the textbook in a digital format, which may be filed by each chapter. The chapters in accordance with the decided guidelines are shown with special symbols, and it is preferable that the textbook is prepared so that the assayer can apparently find that the textbook includes the symbols when the textbook screening is carried out.

Further, it is preferable that document data (text data) organizing chapter data and data of illustrations, tables, photos, etc. (picture data) are managed separately. It is preferable that the textbook data created by the issuer is assayed by the Minister of Education, Culture, Sports, Science and Technology and is granted the certification number after certification. The textbook data may be divided into groups such as “certification number”—“subject number”—“issuer's number (issuer)”—“chapter number”—“document or picture number”. Further, it is preferable that the issuer describes the content according to the guidelines in each textbook. Also, in addition to the content prescribed by the guidelines, other contents may be inserted for characterization of each textbook.

Further, it is preferable that the textbook data is prepared so that more deep learning and search for related matters can be realized. For example, it may be set so that the textbook data in the same section of next grade or previous grade can be browsed, and the textbook data can have links to general homepages. Also, the stored textbook sample fair can be freely browsed at any time and can have links to the same section of another textbook.

Further, a person who can download the textbook exhibited at the textbook sample fair may be limited to a person who obtains a permission number. In such a case, it is preferable that the educationalist is given a permission slip (permission number) before the start of new fiscal year so as to select or arrange the textbook by a free search of the sample fair for the purpose of conducting good classes. Still further, as a method of obtaining the permission slip for non-educationalists, the following step may be taken that the permission slip is issued after solvency check based on a part of personal information provided in advance with a further submitted credit card number, and thereafter downloading is possible.

Further, the present system may be arranged so that data management of the textbook data by each item (chapter) allows selection of most suitable item for each item, instead of a conventional way of selecting a textbook by one volume unit. Still further, the selection of items can reflect characteristics of each school and teacher, or children and students. For example, the purchase of the textbook by chapter is a general rule. Instead, especially educationalists can purchase all chapters in gross, and thereafter, can change a part of chapters into different chapters of another textbook.

More specifically, since the teacher takes the initiative, that is, the responsibility for the textbook creation, the content of the textbook can reflect his personality under the guidelines, needless to say. The textbook can be arranged freely in the textbook sample fair, and the present system checks whether the arranged textbook is sufficiently organized, in other words, whether the arranged textbook is organized in accordance with the guidelines, so that the teacher can add lacking parts to insufficiently arranged textbook. That is, the teacher can create a virtual textbook (original textbook) and decide whether to purchase it after the check. For example, in case where the purchase of the textbook must be permitted by the boards of education or the school principal, it is possible to decide at this point.

For persons involved in the compulsory education, it is possible to request for updating the textbook data and to take advices on the progress of classes. In addition, since the textbook can be arranged according to the progress of classes, it is possible to make children and students to learn ahead in accordance with individual academic abilities, conversely, to make them to review earlier lessons. Also, for other people different from the educationalists, for example, people who want to learn individually, the present system may be arranged so as to sell a part of chapter, that is, by one document or by one picture.

Further, it is preferable that the adopted textbook (items) is filed in each school and is downloaded to users (teachers, children, and students) if necessary.

Still further, the original data (digital paper) stored in the student's terminal 15 may be inhibited to be written. However, it may be arranged so as to be rewritten freely by limited and specific persons. This aims at the arrangement of the textbook for conducting classes more efficiently. Also, this makes it possible to modify the content of the textbook in accordance with levels in learning of children and students so that children and students can learn in accordance with respective academic abilities. Further, since children and students can realize processes to finish lessons one by one corresponding to the guidelines determined in advance, they can learn with fun as if they get through stages of a game.

In the present system, it is preferable that the textbook data, that is, document data (text) or picture data as minimum unit cannot be changed. This aims at following the textbook screening system and protecting copyright. For edition of the chapter data, the present system may be set so that only layouts of document and picture data which organize chapter data can be changed. Also, it may be set so that other materials can be attached to the chapter data. It is preferable that “the content of the textbook cannot be changed”, and it is preferable that the present system may be arranged so that more efficient learning (master) with the textbook is possible.

Further, it is preferable that the original data (textbook data) on the teacher's terminal 14 is rewritten by a dedicated apparatus. This limits the rewriting of the original data and guarantees learning in accordance with the textbook screening. Still further, this helps the teachers to grasp the learning progress of children and students all the time. Yet further, the use of the dedicated apparatus can limit managers.

As a method for changing the setting for rewriting, for example, the technique of Japanese Laid-Open Patent Publication No. 215274/1994 (Tokukaihei 6-215274) can be used. In the technique, it is judged whether the content of a removable security memory coincides with that of a last mode memory which is stored in the main body, and if not coinciding, the user cannot log in to the screen for rewriting. According to this technique, management of the security memory by a manager can control whether rewriting is possible or not.

Also, the technique of Japanese Utility Model Application Laid-Open Publication No. 95488/1990 (Jitsukaihei 2-95488) can be used. In the technique, it is set so that a locking part attached to the modular part which is capable of data communication can inhibit data rewriting mechanically. Removal of the locking part by a special removing equipment is required for data rewriting. Therefore, installation of the removing equipment, for example, at the backroom of teachers' office can discourage data modification by outsiders, children, and students. Further, it is preferable that means for checking whether a person who tries to rewrite is a permitted one, such as personal identification number, password, etc.) are provided.

It is preferable that, in principle, the issuer supplies data including one volume of textbook as usual, computerized textbook (textbook data) is managed by each item, and the teacher can select most suitable item for each item, instead of a conventional way of selecting a textbook by one volume unit.

Further, the present system allows the educationalists, for example, teachers, to create “a virtual textbook (original data)” on a main server (server 11) in accordance with the guidelines authorized by the Minister (Ministry) of Education, Culture, Sports, Science and Technology. For example, as shown in FIG. 4, the teaching guidelines (guidelines) established by the Minister (Ministry) of Education, Culture, Sports, Science and Technology are classified by symbols, which makes it easy to judge whether each textbook satisfies the requirements of the guidelines. Also, as shown in FIG. 5, the symbols are given to each textbook, which makes it easy to check whether learners (teachers, children, students, etc.) have finished the learning of the required items. Thus, the present system realizes the edition of the textbook having a high degree of flexibility while grasping the teaching guidelines (guidelines). In other words, it is possible to promote the education that reflects characteristics of each school, teacher, children and students. Further, as shown in FIG. 5, the original data of textbook may be edited by one volume unit in creating, as is the case of the conventional textbook.

Further, as a method for charging in the present system, for example, each school may pay an annual fee corresponding to the number of children, students, or teachers to a management company of the present system. Address, password, or Identification number (ID number) for access to a homepage such as a textbook sample fair may be given upon the payment of the annual fee. In such a case, it is possible to freely enter into the textbook sample fair upon the input of the address, password, or ID number and to freely download items of a target textbook.

For more effective learning, adoption of suitable edition (textbook) for each chapter is desirable, and also, the method of charging based on the adoption is desirable. That is, a number is given to each chapter, and a counter may be increased by one each time a chapter is downloaded. Upon payment of the annual fee, the number of count for freely downloading is set, and the number of count may vary depending on the amount of the annual fee. Of course, it is preferable that the number of count which the teacher can dispose is large. As a method of counting, the technique of Japanese Laid-Open Patent Publication No. 116493/1998 (Tokukaihei 10-116493) and the technique of Japanese Laid-Open Patent Publication No. 43199/1995 (Tokukaihei 7-43199) can be used.

Further, the amount of charge corresponding to the used data, that is, the number times of downloading or frequency may be settled up at regular intervals from the annual fee that has been paid in advance. According to the conditions, a flexile price setting such as several-fold price for the number of children and students is also preferable, instead of simple calculation by the number of used data or the frequency.

Still further, the present system may be arranged so that counted numbers with respect to each textbook (issuer) is totaled and settled up at the end of the year or at the end of the fiscal year. For example, at the end of the year or at the end of the fiscal year, the amount of charge corresponding to the counted numbers is settled up from the annual fee or a part of the fee that has been paid to each issuer uniformly. In such a case, the amount settled up with respect to a popular textbook is high. A textbook issuer is placed in a more competitive market, so that a textbook having a high quality can be available.

Further, it is preferable that the student's terminal 15 is rented. Children and students rent the student's terminal 15 and are obliged to return the student's terminal 15 on their graduation. The present system may be arranged so as to replace the damaged or broken student's terminal 15 with new one and to demand an additional charge only for willful destruction of the student's terminal 15.

Further, in the ending process (data updating) shown as S15 in FIG. 7, especially data on charge (charging system), that is, personal (client) data of the user such as the chapter data of the textbook data downloaded actually by the user of the teacher's terminal 14, the amount of downloaded data, its costs (charge), the number of times that the user has accessed to the server may be updated among the data stored in the server 11.

Further, the server 11 may be set so that the textbook list of the selected subject, the textbook list of the selected grade, the list of the selected chapter data (by issuer) are displayed in the steps S53, S55, and S57 shown in FIG. 10.

Further, the present invention can be expressed as the following first to seventh textbooks and its distributing method, and a first charging system. That is, in the first textbook and its distributing method, electronic information (digital) is used from edition of the textbook to the use of the textbook in classes.

Still further, the second textbook and its distributing method is that an identification number for each item or each chapter, or in more specific way is granted in the first textbook and its distributing method.

Yet further, the third textbook and its distributing method is that it is possible to create a virtual textbook by a server of a textbook distribution source via a network in the first or second textbook and its distributing method. The fourth textbook and its distributing method is that a permitted person can freely browse the virtual textbook in the third textbook and its distributing method. The fifth textbook and its distributing method is that textbook data for use, which is distributed via the network, is downloaded to a portable electronic display apparatus in the any one of the first to fourth textbooks and its distributing method.

Further, the sixth textbook and its distributing method is that a system for limitation of rewriting is provided in the fifth textbook and its distributing method. The seventh textbook and its distributing method is that a system for canceling the limitation of rewriting is provided in the sixth textbook and its distributing method. Still further, the first charging system is that payment of membership fee is required in any one of the first to seventh textbooks and its distribution.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A textbook distribution apparatus for distributing a textbook to a predetermined receiver, comprising:
a storage section for storing a plurality of textbook data; and
a control section for distributing the textbook data stored in the storage section to an external receiver's terminal in response to an instruction which is supplied from the external receiver's terminal,
wherein the control section is set so as to create an original textbook data by a combination of the plurality of textbook data in response to an instruction which is supplied from a receiver's terminal and to distribute an original textbook data thus created to the receiver's terminal.

2. The textbook distribution apparatus according to claim 1, wherein the textbook data is a collection of chapter data corresponding to chapters which organize the textbook, and the control section is set so as to select chapter data in accordance with an instruction which is supplied from the receiver's terminal and to incorporate chapter data thus selected into the original textbook data.

3. The textbook distribution apparatus according to claim 1, wherein the control section is set so as to determine whether or not the original textbook data, which is created in response to the instruction which is supplied from the receiver's terminal, includes all of particulars prescribed as a content of a textbook.

4. The textbook distribution apparatus according to claims 1, wherein the control section is set so as to receive textbook data transmitted from an external issuer's terminal and to store the textbook data in the storage section.

5. The textbook distribution apparatus according to claim 4, the control section is set so as to transmit the textbook data transmitted from the issuer's terminal to an external assayer's terminal and to store in the storage section only textbook data which is assayed and approved by the assayer's terminal.

6. A textbook distribution system comprising:
(a) a textbook distribution apparatus for distributing a textbook to a predetermined receiver, the textbook distribution apparatus including:
a storage section for storing a plurality of textbook data; and
a control section for distributing the textbook data stored in the storage section to an external receiver's terminal in response to an instruction which is supplied from the external receiver's terminal,
wherein the control section is set so as to create an original textbook data by a combination of the plurality of textbook data in response to an instruction which is supplied from a receiver's terminal and to distribute an original textbook data thus created to the receiver's terminal, and
wherein the control section is set so as to determine whether or not the original textbook data, which is created in response to the instruction which is supplied from the receiver's terminal, includes all of particulars prescribed as a content of the textbook;
(b) an issuer's terminal for transmitting textbook data to the textbook distribution apparatus; and
(c) a receiver's terminal for transmitting an instruction to the textbook distribution apparatus.

7. A textbook distributing method for distributing a textbook to a predetermined receiver, comprising the steps of:
(a) storing a plurality of textbook data in a storage section of a textbook distribution apparatus;
(b) creating an original textbook data by a combination of the plurality of textbook data in response to an instruction supplied from an external receiver's terminal; and
(c) distributing an original textbook data thus created to the receiver's terminal,
the steps (a) through (c) being executed by a control section of the textbook distribution apparatus.

8. A textbook distribution program for making a computer capable of transmitting and receiving data with an external apparatus to function as a control section in a textbook distribution apparatus for distributing a textbook to a predetermined receiver, the textbook distribution apparatus comprising:
a storage section for storing a plurality of textbook data; and
the control section for distributing the textbook data stored in the storage section to an external receiver's terminal in response to an instruction which is supplied from the external receiver's terminal,
wherein the control section is set so as to create an original textbook data by a combination of the plurality of textbook data in response to an instruction which is supplied from a receiver's terminal and to distribute an original textbook data thus created to the receiver's terminal.

9. A textbook distribution program for making a computer capable of transmitting and receiving data with an external apparatus to execute (a) through (c) steps of a textbook distributing method for distributing a textbook to a predetermined receiver, the textbook distributing method comprising the steps of:
(a) storing a plurality of textbook data in a storage section of a textbook distribution apparatus;
(b) creating an original textbook data by a combination of the plurality of textbook data in response to an instruction supplied from an external receiver's terminal; and
(c) distributing an original textbook data thus created to the receiver's terminal.

10. A recording medium for recording a textbook distribution program for making a computer capable of transmitting and receiving data with an external apparatus to function as a control section in a textbook distribution apparatus for distributing a textbook to a predetermined receiver, the textbook distribution apparatus comprising:
a storage section for storing a plurality of textbook data; and
the control section for distributing the textbook data stored in the storage section to an external receiver's terminal in response to an instruction which is supplied from the external receiver's terminal,
wherein the control section is set so as to create an original textbook data by a combination of the plurality of textbook data in response to an instruction which is supplied from a receiver's terminal and to distribute an original textbook data thus created to the receiver's terminal.

11. A recording medium for recording a textbook distribution program for making a computer capable of transmitting and receiving data with an external apparatus to execute (a) through (c) steps of a textbook distributing method for distributing a textbook to a predetermined receiver, the textbook distributing method comprising the steps of:
(a) storing a plurality of textbook data in a storage section of a textbook distribution apparatus;
(b) creating an original textbook data by a combination of the plurality of textbook data in response to an instruction supplied from an external receiver's terminal; and
(c) distributing an original textbook data thus created to the receiver's terminal.

12. A textbook display system in an educational institution, in which a learner's apparatus is provided for storing textbook data obtained from an external apparatus and for displaying textbook data thus obtained in response to an instruction supplied from a learner, the learner's apparatus being a portable apparatus.

13. A textbook distributing method for distributing a textbook to a predetermined receiver, comprising the steps of:
(a) storing a plurality of textbook data;
(b) creating an original textbook data by a combination of the plurality of textbook data in response to an instruction supplied from an external receiver's terminal; and
(c) distributing an original textbook data thus created to the receiver's terminal.

14. A combined data distribution apparatus comprising:
a storage section for storing ready-made data; and
a control section for creating combined data by a combination of a plurality of ready-made data in response to an instruction supplied from a receiver's terminal and for distributing combined data thus created to the receiver's terminal.

15. The combined data distribution apparatus according to claim 14, wherein the ready-made data is data of book.
